(19) United States
(12) Patent Application Publication
(10) Pub. No.: US 2010/0261025 A1
(43) Pub. Date: Oct. 14, 2010

(54) COMPOSITE MOLDED PRODUCT

(75) Inventors: Yasumitsu Miyamoto, Shizuoka (JP); Nobuyuki Matsunaga, Shizuoka (JP)

Correspondence Address: BUCHANAN, INGERSOLL & ROONEY PC, POST OFFICE BOX 1404, ALEXANDRIA, VA, 22313-1404, US

(73) Assignee: Win Tech Polymer Ltd., Minato-ku (JP)

(21) Appl. No.: 12/746,617

(22) PCT Filed: Dec. 18, 2008
(86) PCT No.: PCT/JP2008/003826

§ 371 Date: Jun. 7, 2010

(30) Foreign Application Priority Data
Dec. 21, 2007 (JP) 2007-330133

(51) Int. Cl. B32B 15/09; B29C 45/14

(52) U.S. Cl. 428/458; 264/279

(57) ABSTRACT

Provided is a composite molded product of polybutylene terephthalate resin and metal, having sufficient adhesion strength and being moldable at a mold temperature of 100° C. or lower. Specifically, the composite molded product containing a polybutylene terephthalate resin composition comprising a fibrous reinforcing agent, a polybutylene terephthalate resin and a thermoplastic elastomer, or a modified polybutylene terephthalate resin composition comprising a modified polybutylene terephthalate resin composed of a copolymer of polybutylene terephthalate and isophthalic acid, containing 3 to 50% by mole of isophthalic acid component to the total amount of all the dicarboxylic acid components and a fibrous reinforcing agent and a metal (layer) having a finished finely uneven surface, integrally combined with the composition.

### TECHNICAL FIELD

The present invention relates to a composite molded product composed of a metal and a polybutylene terephthalate resin material.

### BACKGROUND ART

Polybutylene terephthalate resin is used in wide applications such as automobile parts, electric and electronic parts, as an engineering plastic owing to the excellent mechanical characteristics, electric characteristics, heat resistance, and chemical resistance. There have also been utilized composite molded products manufactured by insert-molding and outsert-molding of polybutylene terephthalate with metal. To manufacture those types of composite molded products of resin and metal, studies have long been carried out in the laminate field as the technologies of resin-adhesion to the metal surface, including various technologies to attain adhesiveness through the injection molding of a thermoplastic resin after forming a finely uneven surface to form on the metal surface.

For example, JP-A2001-225352 discloses a method of chemical etching on the surface of metal in advance, and JP-A 2003-103563 discloses a method of treating metal surface with an aqueous reducing agent such as hydrazine. JP-A 2006-1216 provides a method of using an aluminum alloy having a finished finely uneven surface by alumite treatment, and JP-A 2003-170531 provides a method of conducting injection molding using a metal surface-treated with an aqueous amine-based compound, wherein a polybutylene terephthalate resin contains an amorphous resin such as polycarbonate, polystyrene, or ABS to attain further strong joining strength.

These methods, however, result in insufficient chemical resistance and heat resistance depending on the usage environment, and may deteriorate the toughness, specifically impact strength. For that type of composite molded products, it is commonly known that higher mold temperature improves more the adhesion strength between the metal and the resin. Nevertheless, in the market, the molding working is required at a relatively low mold temperature, specifically at a mold temperature applicable to a water temperature controller.

### DISCLOSURE OF THE INVENTION

An object of the present invention is to provide a composite molded product of polybutylene terephthalate resin and metal, having sufficient adhesion strength and being moldable at a mold temperature of 100° C. or lower.

To attain the above object, the inventors of the present invention conducted detail study. According to the study, a polybutylene terephthalate resin composition containing a fibrous reinforcing agent and a thermoplastic elastomer, or a modified polybutylene terephthalate resin composition containing a fibrous reinforcing agent was used as the polybutylene terephthalate resin material, and then the composition is injection-molded onto the surface of a metal having a finished finely uneven surface in advance, and they have found that the obtained composite molded product provided good adhesion strength even at a mold temperature of 100° C. or lower and was able to apply in varieties of use environments in the market. Based on the finding, the inventors have perfected the present invention.

The present invention provides a composite molded product containing:

a polybutylene terephthalate resin composition containing a fibrous reinforcing agent, polybutylene terephthalate resin and a thermoplastic elastomer, or

a modified polybutylene terephthalate resin composition containing a modified polybutylene terephthalate resin composed of a copolymer of polybutylene terephthalate and isophthalic acid, containing 3 to 50% by mole of isophthalic acid component to the total amount of all the dicarboxylic acid components and a fibrous reinforcing agent and

a metal (layer) having a finished finely uneven surface, integrally combined with the composition.

According to the present invention, injection-molding of a specific polybutylene terephthalate resin composition onto the surface of a metal having a finished finely uneven surface improves the adhesion between the resin and the metal in a field where integral injection molding with metal such as insert molding and outsert molding has been carried out, and thus the metal working for tightly attaching the resin to the metal can be simplified. As a result, the degree of freedom in design increases to obtain composite molded products with more unlimited shapes.

### DETAIL DESCRIPTION OF THE INVENTION

The present invention will be described in more detail in the following.

The polybutylene terephthalate resin material used in the present invention is (1) a polybutylene terephthalate resin composition containing a fibrous reinforcing agent and a thermoplastic elastomer, or (2) a modified polybutylene terephthalate resin composition containing a fibrous reinforcing agent and a modified polybutylene terephthalate resin composed of a copolymer of polybutylene terephthalate resin and isophthalic acid, containing 3 to 50% of isophthalic acid component to the total amount of dicarboxylic acid component. In this case, in the aspect (1), polybutylene terephthalate resin may be used alone as the polybutylene terephthalate resin, or both the polybutylene terephthalate resin and the modified polybutylene terephthalate resin may be used in combination.

In the aspect (2), both the modified polybutylene terephthalate resin and the polybutylene terephthalate resin may be used in combination.

In particular, when the shortening of molding cycle is desired in order to improve the productivity, implementing the aspect (1) is preferable depending on the situation.

The polybutylene terephthalate resin used in the present invention is a polybutylene terephthalate obtained by polycondensation of terephthalic acid or an ester-forming derivative thereof with a C₄ alkylene glycol or an ester-forming derivative thereof. The polybutylene terephthalate may be a copolymer containing 70% by weight or more thereof.

Examples of the dibasic acids other than terephthalic acid or an ester-forming derivative thereof (such as lower alcohol ester) are: aliphatic and aromatic polybasic acids such as naphthalene dicarboxylate, adipic acid, sebacic acid, trimellitic acid or and succinic acid; or an ester-forming derivative thereof. Examples of the glycol component other than 1,4-butanediol are: normal alkylene glycols such as ethylene glycol, diethylene glycol, propylene glycol, trimethylene glycol, hexamethylene glycol, neopentyl glycol or cyclohexane dimethanol; lower alkylene glycol such as 1,3-octane diol; aromatic alcohols such as bisphenol A or 4,4′-dihydroxybiphenyl; alkylene oxide adduct alcohol such as ethylene oxide 2-mole adduct of bisphenol A or propylene oxide 3-mole adduct of bisphenol A; and polyhydroxy compound such as glycerin or pentaerythritol, or an ester-forming derivative thereof.

According to the present invention, any of the polybutylene terephthalates prepared by polycondensation of the above compounds as the monomer components can be used as the (A) component of the present invention, and they can be used alone or as a mixture of two or more of them. Furthermore, a branched polymer belonging to the copolymer can also be used. The term “polybutylene terephthalate branched polymer” referred to herein signifies a polyester prepared from so-called polybutylene terephthalate or butylene terephthalate monomer as the main component, while adding a polyfunctional compound thereto to generate branched structure. Applicable polyfunctional compound includes trimesic acid, trimellitic acid, pyromellitic acid, alcohol ester thereof, grycerin, trimethylol ethane, trimethylol propane, and pentaerythritol.

The modified polybutylene terephthalate resin referred to herein signifies a copolymer of polybutylene terephthalate and isophthalic acid, containing 3 to 50% by mole of isophthalic acid component to the total amount of dicarboxylic acid component. That kind of copolymer of polybutylene terephthalate and isophthalic acid is prepared by substituting a part of the terephthalic acid or an ester-forming derivative thereof in the above polybutylene terephthalate with isophthalic acid. Also in order as well to keep the characteristics as the crystalline resin, the ones obtained through the modification by 3 to 50% by mole to the amount of the terephthalic acid component are commonly used. If the modification rate is less than 3% by mole, sufficient adhesion to metal cannot be attained in the absence of the elastomer component. If the modification rate exceeds 50% by mole, the solidification speed decreases, which may deteriorate the productivity in some cases.

Isophthalic acid is used for polycondensation in a form of ester-formable derivative such as lower alcohol ester such as dimethyl ester, and can be added as a copolymer component.

Furthermore, if the modification rate is within the above range, a mixture of two or more of copolymers of polybutylene terephthalate and isophthalic acid having different content of isophthalic acid can also be used as the modified polybutylene terephthalate resin of the present invention.

The polybutylene terephthalate resin and the modified polybutylene terephthalate resin are required to have the intrinsic viscosity (IV) within the range of 0.6 to 1.2 dl/g, preferably 0.65 to 1.0 dl/g, and more preferably 0.65 to 0.8 dl/g, in o-chlorophenol to be used as the solvent and measured at 35° C. If the intrinsic viscosity is less than 0.6 dl/g, the amount of gas to be generated from polybutylene terephthalate resin such as tetrahydrofuran cannot be sufficiently decreased, which is not preferable as the poor appearance at the time of the molding and deposit-adhesion result. If the intrinsic viscosity exceeds 1.2 dl/g, the flowability during molding deteriorates.

The thermoplastic elastomer releases strain and stress generated by the difference between the linear expansion coefficient of metal and the shrinkage rate of resin during molding, and by the difference in linear expansion coefficient between the metal and the resin after joining. The kind of the elastomer is not specifically limited. Since, however, the elastomer is added to the polybutylene terephthalate resin which is an engineering plastic, preferred ones are, in consideration of the heat resistance and the chemical resistance, core-shell type elastomer, olefin-based elastomer, and polyester-based elastomer.

The blending ratio of the thermoplastic elastomer is 3 to 100 parts by weight, and preferably from 10 to 50 parts by weight, to 100 parts by weight of the polybutylene terephthalate resin. If the blending ratio of the thermoplastic elastomer is less than 3 parts by weight, sufficient effect on the adhesion between the metal and the resin cannot be obtained. If the blending ratio thereof exceeds 100 parts by weight, the properties as the crystalline resin decrease, and there is a possibility of not being able to satisfy the required performances such as heat resistance and chemical resistance as the polybutylene terephthalate resin composition.

The core-shell type elastomer is an elastomer composed of a flexible core layer and a shell layer having a high elastic modulus. The core layer contains a rubber-like core polymer by an amount of 20 to 70% by weight. That type of rubber-like core polymer is derived from: at least one kind of C₁-C₈ alkylacrylate monomer (methyl-, ethyl-, propyl-, n-butyl-, sec-butyl-, tert-butyl-, pentyl-, hexyl-, heptyl-, n-octyl-, and 2-ethylhexyl acrylate); or at least one kind of ethylenic unsaturated copolymer monomer different from the C₁-C₈ alkylacrylate monomer, and contains a unit derived from at least one kind of cross-linking agent or graft-linker, (such as unsaturated carboxylic allyl ester such as allyl methacrylate).

The shell layer of acrylic core-shell type elastomer is preferably a shell polymer grafted to the core polymer, and contains 1 to 20% by weight, preferably 3 to 15% by weight, and more preferably 4 to 8% by weight, of a unit derived from at least one kind of copolymerizable ethylenic unsaturated monomer, different from at least one kind of the above C₁-C₈ alkylmethacrylate monomers derived from at least one kind of C₁-C₈ alkyl methacrylate monomers.

Preferred copolymerizable ethylenic unsaturated monomers include C₁-C₈ alkyl(meth)acrylate, acrylonitrile, methacrylonitrile, divinylbenzene, alpha-methylstyrene, para-methylstyrene, chlorostyrene, vinyltoluene, dibromostyrene, tribromostyrene, vinylnaphthalene, isopropenylnaphthalene, and alkyl(meth)acrylates with larger carbon numbers C₉-C₂₀ such as decylacrylate, laurylmethacrylate, laurylacrylate, stearylmethacrylate, stearylacrylate, and isobonylmethacrylate. In addition, among them, the C₁-C₈ alkyl (meth)acrylate monomer is preferred owing to the improved weatherability, and C₁-C₈ alkylacrylate monomer is most preferable.

The polyolefin-based elastomer includes the one in which styrene or acrylonitrile-styrene copolymer has been grafted, with main chain of polyolefin and side chain of vinyl-based polymer. The polyolefin to be used as the main chain includes copolymer of ethylene, propylene, and isoprene with aliphatic vinyl esters (such as vinyl acetate or vinyl propionate), and acrylic acid esters (acrylic acid C₁-C₁₀ alkyl ester such as ethyl acrylate, butyl acrylate or 2-ethylhexyl acrylate). Such kinds of olefin-based main chains are exemplified as ethylene-vinyl acetate copolymer, ethylene-acrylic acid C₁-C₈ alkyl ester copolymer (ethylene-ethyl acrylate copolymer, (EEA), and ethylene-butyl acrylate copolymer), ethylene-acrylic acid C₁-C₈ alkylester-methacrylic acid copolymer, ethylene-styrene copolymer and the like.

Polyester-based elastomer includes a copolymer of hard segment composed of a short-chain ester and a soft segment composed of a polyether component having a number-average molecular weight of about 200 to 6000 and a polyester component having a number-average molecular weight of about 200 to 10000, with a ratio of the hard segment to the soft segment of 20 to 90% by weight to 80 to 103 by weight, preferably 30 to 85% by weight to 70 to 15% by weight. Preferred dicarboxylic acid component constituting the polyester hard segment includes terephthalic acid and isophthalic acid. Preferred diol components constituting the polyester hard segment include aliphatic or alicyclic diols having a carbon number of 2 to 12, or alicyclic diols such as ethylene glycol, propylene glycol, 1,4-butane diol, 1,4-butene diol, neopentyl glycol, 1,5-pentane diol, and 1,6-hexane diol; and bisphenols such as bis (p-hydroxy) diphenyl, bis (p-hydroxyphenyl) methane or bis (p-hydroxyphenyl); and a mixture thereof. As the polyether component constituting the soft segment, poly(alkylene oxide) glycol is specifically preferred, and more specifically poly(tetramethylene oxide)glycol is preferred. As for the polyester component constituting the soft segment, preferred one is a polycondensate of compound of C₂-C₁₂ aliphatic hydrocarbon having carboxylic acid and alcohol terminal within the same molecule, or an open-ring polymer of cyclic ester, and a caprolactone polymer and the like are preferred.

Among these thermoplastic elastomers, core-shell type elastomer and olefin-based elastomer are preferably used under a usage environment requiring hydrolysis resistance and heat aging resistance.

To the resin composition used in the present invention, a fibrous reinforcing agent is added in order to improve the mechanical strength such as tensile strength, to suppress the shrinkage of the molded product, and to improve the adhesion with metal.

Examples of the fibrous reinforcing agent include: inorganic fiber (such as glass fiber, carbon fiber, silica-alumina fiber, zirconia fiber, metal fiber such as fiber of stainless steel, aluminum, titanium, copper, or brass); and organic fiber (such as aromatic polyamide fiber, fluorine resin fiber, or liquid crystalline aromatic fiber). One or two or more of them are used or in combination thereof. In terms of availability and cost, glass fiber is preferably used.

The mean fiber diameter of the fibrous reinforcing agent is not specifically limited, and for example, is within the range of 1 to 100 μm (for example, 1 to 50 μm), and preferably about 3 to 30 μm. The mean fiber length of the fibrous reinforcing agent is also not specifically limited, and for example, is within the range of about 0.1 to 20 mm.

As the fibrous reinforcing agent, the one having a circular cross section is normally used. In view of preventing the decrease in the adhesion after molding while suppressing the warp deformation of the molded product, a modified cross-section glass may be used.

In addition, the fibrous reinforcing agent may be surface-treated, as necessary, through the use of a conversing agent or a surface-treatment agent (such as functional compound including epoxy-based compound, acrylic-based compound, isocyanate-based compound, silane-based compound, or titanate-based compound). The fibrous reinforcing agent may be preliminary surface-treated by the conversing agent or the surface-treatment agent described above, or may be surface-treated in preparing the material by the addition of the conversing agent or the surface-treatment agent.

The blending ratio of the fibrous reinforcing agent is within the range of 20 to 100 parts by weight to 100 parts by weight of the polybutylene terephthalate resin and/or the modified polybutylene terephthalate resin. If the blending ratio thereof is less than 20 parts by weight, the adhesion with metal may decrease, and the mechanical properties become insufficient. If the blending ratio thereof exceeds 100 parts by weight, the melt-kneading property deteriorates and the moldability decreases. As a result, the adhesion with metal also decreases, which is not preferable.

To the resin composition to be used in the present invention, an inorganic filler other than the above fibrous reinforcing agent can be added. Examples of the inorganic filler include: silicates such as mica, talc or bentonite; calcium carbonate; magnesium hydroxide; boehmite; zinc sulfate; zinc oxide; glass flake and glass bead, or the like. One or more of them can be used. With the addition of them at an adequate amount, the difference in the shrinkage and linear expansion between the resin and the metal can be alleviated.

Furthermore, to the resin composition of the present invention, there may be added, as necessary, common additives including stabilizers such as antioxidant, UV absorber, thermal stabilizer or weathering stabilizer, lubricator, releasing agent, and coloring agent.

In addition, to the resin composition to be used in the present invention, there can be added other thermoplastic resins (such as polyamide, acrylate, polycarbonate, polyallylate, polylactate, polystyrene, polyphenylene ether, AS or ABS), and thermosetting resins (such as unsaturated polybutylene terephthalate resin, phenol resin or epoxy resin), to an extent not deteriorating the performance as the polybutylene terephthalate resin.

The polybutylene terephthalate resin composition to be used in the present invention may be in a form of mixture of powder and particle, or in a form of molten mixture. The polybutylene terephthalate resin composition can be prepared by mixing with an inorganic filler, an additive, and the like, as necessary, by a common mixing method. For example, individual components are blended together, and the mixture is kneaded and extruded through a single-screw or twin-screw extruder to thereby form pellets thereof.

Through the use of thus prepared polybutylene terephthalate resin composition and the metal having a finished finely uneven surface, the composite molded product can be obtained by injection molding.

Specifically the polybutylene terephthalate resin composition to be used in the present invention can provide good adhesion even at the molding temperature of 100° C. or lower, which is within the temperature of ordinary water temperature controller, and the mold temperature is not required to be increased more than necessary.

The method of surface treatment of metal used in the present invention is not specifically limited, and any method can be selected depending on the metal material and shape, required properties, and the like. The finishing on the metal surface into a fine and uneven surface includes, for example, chemical etching, alumite treatment on aluminum, and physical treatments such as liquid horning or sand blasting, as well as working by electroless plating. As for the chemical etching, varieties of methods of treating the metal surface by synthetic chemicals and the like are provided depending on the kinds of metal and the purposes of the treatment, and they are applied in various industrial fields. Specific examples of the etching method are disclosed in JP-A 10-96088 and JP-A 10-56263. The method is not specifically limited, and any of conventional methods can be selected.

The alumite treatment is a common surface treatment method applied to aluminum, which allows forming porous structure at an order of several tens of nanometers to several tens of micrometers by electrolysis of aluminum at cathode through the use of an acid. The TRI treatment and the like are known as a method of forming not only concavities on the surface but also convexes thereon. In these manners, the finishing on the metal surface into a fine and uneven surface is to form fine unevenness in a size of several tens of nanometers to several tens of micrometers through the use of chemical, physical, or electrical method, or by the combination thereof. Thus, the effect of the present invention is attained. If the diameter of unevenness becomes further finer, the confirmation is difficult and the penetration of resin during molding becomes difficult. If the unevenness diameter becomes excessively larger, the contact area with the resin decreases, which makes it difficult to attain a desired joint strength.

The kinds of the metal to be used in the present invention are not specifically limited, and there can be used, for example, copper, aluminum, magnesium, nickel, titanium, iron, and the like, and an alloy thereof. In addition, a metal with plating of nickel, chromium, gold, and the like is applicable.

### BRIEF DESCRIPTION OF THE DRAWINGS

FIG. 1 illustrates a configuration of a composite molded product for measuring the adhesion strength.

FIG. 2 illustrates the condition of measuring the adhesion strength of the composite molded product.

FIG. 3 illustrates a configuration of the composite molded product used for an air-tight test.

FIG. 4 illustrates the condition of the air-tight test of the composite molded product.

### EXAMPLES

The present invention will be described below in more detail referring to Examples. The present invention, however, is not limited by them. The term “parts” in Examples signifies the “weight parts”.

### Examples 1 to 7, Comparative Examples 1 to 3

The polybutylene terephthalate resin composition shown in Table 1 was prepared by being compounded through the use of a twin-screw extruder (produced by The Japan Steel Works, Ltd.) at a cylinder temperature of 260° C.

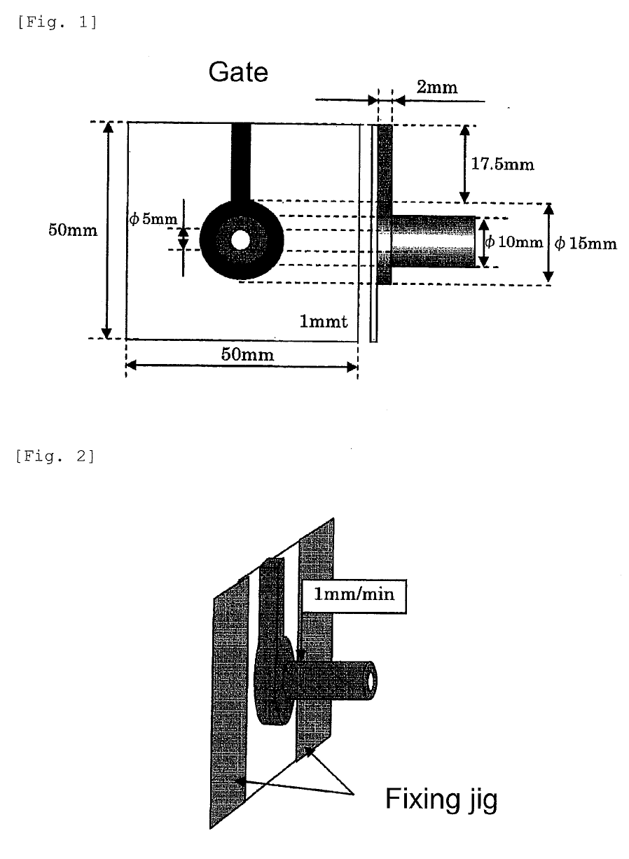

The obtained resin composition was fed to an injection molding machine (manufactured by Sodick Co., Ltd.) to thereby form a composite molded product for measuring adhesion strength, illustrated in FIG. 1. The metal used was the one treated by “NMT treatment of Taiseiplus Co., Ltd.” which is known as a type of chemical etching on aluminum (Al050). The molding was conducted under two mold-temperature conditions of 90° C. and 140° C. Regarding the adhesion strength, the fracture strength was measured using the composite molded product shown in FIG. 1 by a method of pressing the protrusion against a jig moving at a constant speed, as illustrated in FIG. 2. The measurement was done using Tensilon UTA-50KN-RTC manufactured by Orientec Co., Ltd. As shown in Table 1, only the samples of Examples showed high adhesion at 90° C. of mold temperature, though all the tested samples exhibited high adhesion at 140° C. of mold temperature.

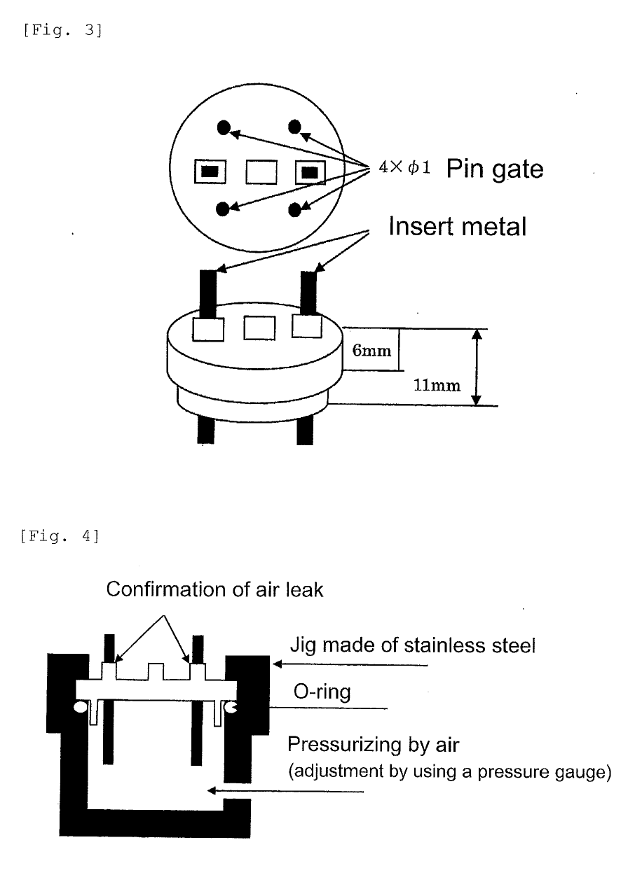

As for the air-tight test, the composite molded product illustrated in FIG. 3 was obtained by applying insert-molding to the aluminum pin surface-treated in the same way as above at a mold temperature of 90° C. Thus prepared composite molded product was mounted to the jig illustrated in FIG. 4, and a pressure was applied to the product by compressed air. The evaluation was carried out by confirming the air leak from interface between the metal and the resin. The applied pressure increased in increments of 0.1 MPa while holding the pressure for 1 minute. When the air leak was not observed, the pressure was increased by further 0.1 MPa until the pressure reached 0.6 MPa. The result is shown in Table 1.

The detail of components used is as follows.

Polybutylene terephthalate resin: polybutylene terephthalate resin with an intrinsic viscosity of 0.7 dl/g (manufactured by WinTech Polymer, Ltd.)

Copolymer of polybutylene terephthalate and isophthalic acid: Polybutylene terephthalate copolymer in which 12.5% by mole of terephthalic acid in polybutylene terephthalate skeleton has been modified by using isophthalic acid, (intrinsic viscosity of 0.74 dl/g, manufactured by WinTech Polymer, Ltd.)

Elastomer

a: Polyester-based elastomer (Perplene GP400, manufactured by Toyobo Co., Ltd.)
b: Core-shell type elastomer (Paraloid EXL-2311, manufactured by Rhome and Haas Chemical Company)
c: Olefin-based elastomer (Modiper A5300, manufactured by NOF Corporation)
Fibrous reinforcing agent: Glass fiber (013, manufactured by Nippon Electric Glass Co., Ltd.)

TABLE 1

| | Examples | | | | | | | Comparative Examples | | |
|---|---|---|---|---|---|---|---|---|---|---|
| | 1 | 2 | 3 | 4 | 5 | 6 | 7 | 1 | 2 | 3 |
| Polybutylene terephthalate resin (parts) | 100 | 100 | 100 | 100 | 75 | | | 100 | 100 | 100 |
| Copolymer of polybutylene terephthalate and | | | | | 25 | 100 | 100 | | | |
| isophthalic acid (parts) | | | | | | | | | | |
| Elastomer a (parts) | 17 | | | | | | | | | |
| Elastomer b (parts) | | 17 | 40 | | 17 | 17 | | | | |
| Elastomer c (parts) | | | | 17 | | | | | | |
| Glass fiber (parts) | 50 | 50 | 60 | 50 | 50 | 50 | 43 | 18 | 43 | 82 |
| Adhesion strength (N) mold temperature: 90° C. | 358 | 335 | 290 | 301 | 360 | 378 | 356 | 91 | 10 | 21 |
| Adhesion strength (N) mold temperature: 140° C. | 416 | 438 | 465 | 405 | 435 | 421 | 376 | 469 | 397 | 376 |

| | |
|---|---|
| Air-tightness mold temperature: 90° C. | No leak up to 0.6 MPa |

1. A composite molded product comprising:
a polybutylene terephthalate resin composition comprising a fibrous reinforcing agent, polybutylene terephthalate resin and a thermoplastic elastomer, or
a modified polybutylene terephthalate resin composition comprising a modified polybutylene terephthalate resin composed of a copolymer of polybutylene terephthalate and isophthalic acid, containing 3 to 50% by mole of isophthalic acid component to the total amount of all the dicarboxylic acid components and a fibrous reinforcing agent, and
a metal (layer) having a finished finely uneven surface, integrally combined with the composition.

2. The composite molded product according to claim 1, wherein the content of the fibrous reinforcing agent is 20 to 100 parts by weight to 100 parts by weight of the polybutylene terephthalate resin and/or the modified polybutylene terephthalate resin.

3. The composite molded product according to claim 1, wherein the content of the thermoplastic elastomer is 3 to 100 parts by weight to 100 parts by weight of the polybutylene terephthalate resin.

4. The composite molded product according to claim 3, wherein the thermoplastic elastomer is one or more selected from the group consisting of a core-shell type elastomer, an olefin-based elastomer, and a polyester-based elastomer.

5. The composite molded product according to claim 1, wherein the fibrous reinforcing agent is glass fiber.

6. The composite molded product according to claim 1, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

7. The composite molded product according to claim 6, prepared with the mold at a mold temperature of 100° C. or lower.

8. The composite molded product according to claim 3, wherein the fibrous reinforcing agent is glass fiber.

9. The composite molded product according to claim 4, wherein the fibrous reinforcing agent is glass fiber.

10. The composite molded product according to claim 2, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

11. The composite molded product according to claim 3, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

12. The composite molded product according to claim 4, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

13. The composite molded product according to claim 5, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

14. The composite molded product according to claim 8, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

15. The composite molded product according to claim 9, prepared by the steps of placing a metal having a finished finely uneven surface in a mold in advance, and conducting injection molding of the polybutylene terephthalate resin composition comprising a fibrous reinforcing agent, polybutylene terephthalate resin and a thermoplastic elastomer, or the modified polybutylene terephthalate resin composition containing a fibrous reinforcing agent against the treating surface.

16. The composite molded product according to claim 10, prepared with the mold at a mold temperature of 100° C. or lower.

17. The composite molded product according to claim 11, prepared with the mold at a mold temperature of 100° C. or lower.

18. The composite molded product according to claim 12, prepared with the mold at a mold temperature of 100° C. or lower.

19. The composite molded product according to claim 13, prepared with the mold at a mold temperature of 100° C. or lower.

20. The composite molded product according to claim 14, prepared with the mold at a mold temperature of 100° C. or lower.
